(19) United States
(12) Patent Application Publication
(10) Pub. No.: US 2011/0204814 A1
(43) Pub. Date: Aug. 25, 2011

(54) INORGANIC ELECTROLUMINESCENCE DEVICE AND METHOD OF MANUFACTURING THE SAME

(75) Inventors: Min-jong BAE, Yongin-si (KR); Shang-hyeun PARK, Yongin-si (KR); Tae-won JEONG, Yongin-si (KR); Seong-eui LEE, Seongnam-si (KR)

(73) Assignee: SAMSUNG ELECTRONICS CO., LTD., Suwon-si, (KR)

(21) Appl. No.: 12/958,651

(22) Filed: Dec. 2, 2010

(30) Foreign Application Priority Data
Feb. 23, 2010 (KR) 10-2010-0016342

(51) Int. Cl. H05B 37/02; H01J 1/62; B32B 38/04

(52) U.S. Cl. 315/291; 313/483; 156/252

(57) ABSTRACT

An inorganic electroluminescence device includes a substrate, a first electrode layer including a plurality of segment electrodes disposed on the substrate and separated from each other, a phosphor layer on the first electrode layer, a dielectric layer on the phosphor layer, and a second electrode layer on the dielectric layer. A voltage is applied to each of the plurality of segment electrodes so that the inorganic electroluminescence device can be turned on or turned off.

### CROSS-REFERENCE TO RELATED APPLICATIONS

This application claims priority to Korean Patent Application No. 10-2010-0016342, filed on Feb. 23, 2010, and all the benefits accruing therefrom under 35 U.S.C. §119, the disclosure of which is incorporated herein in its entirety by reference.

### BACKGROUND

1. Field

Provided is an inorganic electroluminescence device and a method of manufacturing the same.

2. Description of the Related Art

An electroluminescence device is used as a lamp-shaped light source or as an active light-emitting display device, by using a phenomenon in which electrical energy is converted into light energy. Electroluminescence devices are classified into organic electroluminescence devices and inorganic electroluminescence devices according to material used to form an emission layer.

Among inorganic electroluminescence devices, a powder inorganic electroluminescence devices is widely used as a light source, such as in a keypad for a mobile phone, an advertising board, simple medical equipment, or the like. However, it is difficult to implement inorganic electroluminescence devices due to cross-talk that occurs when a display device is driven.

Inorganic electroluminescence devices are driven in units of lines by using a passive matrix driving method. In the passive matrix driving method, as the number of pixels increases, brightness of an inorganic electroluminescence device is greatly lowered.

### SUMMARY

Provided are inorganic electroluminescence devices in which a cross-talk is reduced when an inorganic electroluminescence device is employed in a display device.

Also provided are inorganic electroluminescence devices having improved brightness.

Also provided are methods of manufacturing inorganic electroluminescence devices that may be simply manufactured.

Provided is an inorganic electroluminescence device includes a substrate, a first electrode layer including a plurality of segment electrodes disposed on the substrate to be separated from each other, a phosphor layer on the first electrode layer, a dielectric layer on the phosphor layer, and a second electrode layer on the dielectric layer.

A wire for applying a voltage to each of the plurality of segment electrodes may be installed on the substrate.

The inorganic electroluminescence device may further include an electrical wiring layer separate from the substrate in which the wire for applying a voltage to each of the plurality segment electrodes is installed facing a lower portion of the substrate.

The inorganic electroluminescence device may further include via holes disposed in the substrate and corresponding to the plurality of segment electrodes, respectively, and a conductor filled into each of the via holes. Each of the segment electrodes is electrically connected to the wire of the electrical wiring layer via the conductor.

The inorganic electroluminescence device may further include a plurality of electrical wiring layers separate from the substrate in which the wire for applying a voltage to each of the plurality segment electrodes is installed facing a lower portion of the substrate.

The inorganic electroluminescence device may further include first via holes disposed through the substrate and corresponding to a portion of the plurality of segment electrodes, and second via holes disposed through at least one of the substrate and a plurality of electrical wiring layers and corresponding to a remaining portion of the plurality of segment electrodes.

A voltage may be independently applied to each of the plurality of segment electrodes.

The plurality of segment electrodes may be disposed in a form of a matrix.

The second electrode layer may include a common electrode.

The inorganic electroluminescence device may be driven by passive matrix driving.

Provided is a method of manufacturing an inorganic electroluminescence device, the method including forming first via holes on a substrate, filling a conductor into each of the first via holes, stacking a first electrode layer on the substrate, patterning the first electrode layer by using a screen printing process so as to form a plurality of segment electrodes, forming a first electrical wiring layer connected to the conductor filled into each of the first via holes, aligning the substrate, the first electrode layer, and the first electrical wiring layer based on the conductor filled into each of the first via holes and firing the substrate, the first electrode layer, and the first electrical wiring layer by using a low temperature co-firing ceramics (“LTCC”) process, stacking a phosphor layer on the first electrode layer, stacking a dielectric layer on the phosphor layer, and stacking a second electrode layer on the dielectric layer.

### BRIEF DESCRIPTION OF THE DRAWINGS

These and/or other elements will become apparent and more readily appreciated from the following description of the embodiments, taken in conjunction with the accompanying drawings of which:

FIG. 1 is a partially-cut perspective view of an embodiment of an inorganic electroluminescence device, according to the present invention;

FIG. 2 illustrates an embodiment of an electrode structure of the inorganic electroluminescence device of FIG. 1;

FIG. 3A is an exploded perspective view of another embodiment of an electrode structure of the inorganic electroluminescence device of FIG. 1;

FIG. 3B is a combined cross-sectional view of the electrode structure of FIG. 3A;

FIG. 4A is an exploded perspective view of an embodiment of the inorganic electroluminescence device of FIG. 1, including a plurality of electrical wire layers;

FIG. 4B is a combined cross-sectional view of an electrode structure of FIG. 4A; and

FIGS. 5A through 5E are cross-sectional views illustrating an embodiment of a method of manufacturing an inorganic electroluminescence device, according to the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain elements of the present description.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, “connected” may refer to physically and/or electrically connected. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

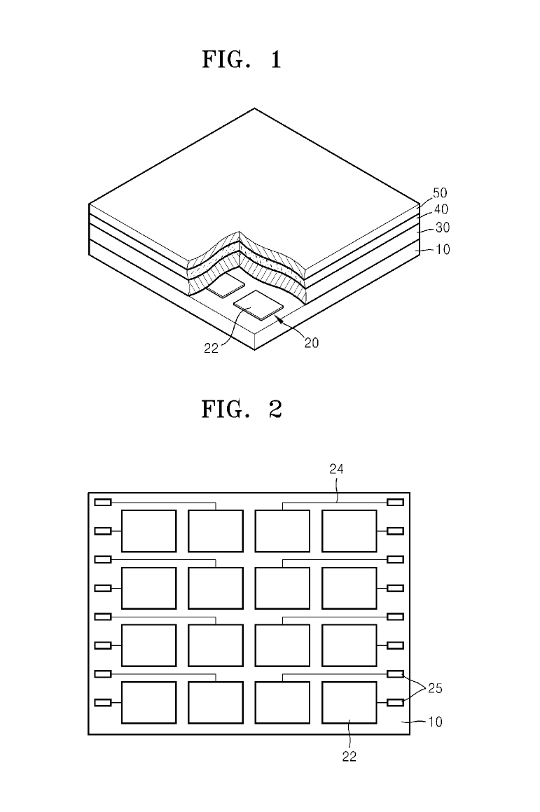

FIG. 1 is a partially-cut perspective view of an embodiment of an inorganic electroluminescence device, according to the present invention.

Referring to FIG. 1, in the inorganic electroluminescence device according to the illustrated embodiment of the present invention, a first electrode layer 20 is disposed on a substrate 10, and a phosphor layer 30 is disposed on the first electrode layer 20. Also, a dielectric layer 40 is disposed on the phosphor layer 30, and a second electrode layer 50 is disposed on the dielectric layer 40. The phosphor layer 30, the dielectric layer 40 and/or the second electrode layer 50 are disposed overlapping an entire of the substrate 10.

The substrate 10 may be an insulating substrate, and may be a glass substrate, for example. The phosphor layer 30 may be a powder type. At least one of the first electrode layer 20 and the second electrode layer 30 may include an indium tin oxide (“ITO”) transparent electrode, where an electrode that emits light and is near the phosphor layer 30 may be a transparent electrode.

The inorganic electroluminescence device of FIG. 1 is a bottom view light-emitting device, where the first electrode layer 20 may include a transparent electrode. Conversely, in a top view light-emitting device, a phosphor layer 30 is disposed on a dielectric layer 40 opposite to the substrate 10, and light is emitted toward an upper side of the inorganic electroluminescence device. The inorganic electroluminescence device of FIG. 1 may be applied to the top view light-emitting device.

The first electrode layer 20 includes a plurality of a segment electrode 22 disposed separated from each other, in a plan view of the substrate. In an embodiment, for example, the segment electrodes 22 may be arranged in the form of a matrix. The second electrode layer 50 may include a common electrode corresponding to the segment electrodes 22. As used herein, “corresponding” indicates being the same in number, dimension and/or positional placement relative to another element.

A voltage may be independently applied to the segment electrodes 22. Although the segment electrodes 22 are disposed on a lower portion of the inorganic electroluminescence device, as illustrated in FIG. 1, the segment electrodes 22 may be disposed on an upper portion of the inorganic electroluminescence device in an alternative embodiment. In other words, the second electrode layer 50 may include the segment electrodes 22, and the first electrode layer 20 may include the common electrode.

The inorganic electroluminescence device of FIG. 1 may be driven via passive matrix driving, wherein a voltage may be independently applied to the segment electrodes 22. The voltage is applied to each of the segment electrodes 22 so that a cross-talk or lowering of brightness due to passive matrix driving may be reduced. When the inorganic electroluminescence device of FIG. 1 is employed in a display device, a single segment electrodes 22 may be disposed in one pixel region, and the segment electrode 22 is independently driven so that a turning on/off of the inorganic electroluminescence device of FIG. 1 may be controlled according to an image signal in each pixel region and images may be displayed. Alternatively, more than one segment electrode 22 may be disposed in one pixel region, and the more than one segment electrode 22 are driven so that a turning on/off of the inorganic electroluminescence device of FIG. 1 may be controlled according to an image signal in each pixel region and images may be displayed.

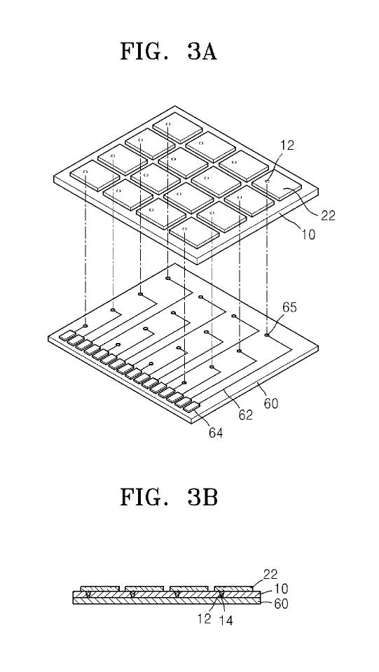

There may be various electrode structures for independently applying a voltage to the segment electrodes 22. FIG. 2 illustrates an example of the first electrode layer 20 including the segment electrodes 22. The segment electrodes 22 may be disposed on the substrate 10, and a wire 24 for independently applying a voltage to the segment electrodes 22 may be installed on the substrate 10. The wire 24 is connected at a first end to a segment electrode 22. The wire 24 is connected at a second end opposite to the first end, to a terminal 25 that corresponds to the wire 24. In FIG. 2, both the segment electrodes 22 and the wire 24 are disposed on the substrate 10. In detail, the segment electrodes 22 and the wire 24 may be disposed on a same layer, that is, on a same surface of the substrate 10. The wire 24 is disposed in one-to-one correspondence with both the segment electrodes 22 and the terminals 25.

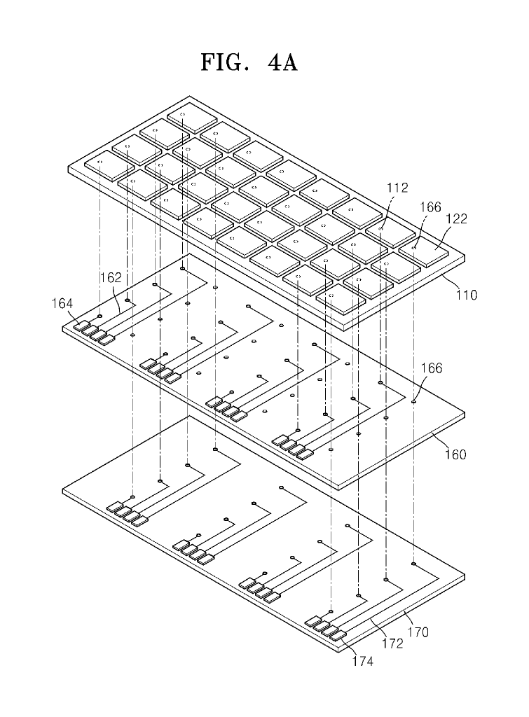

FIGS. 3A and 3B illustrate another embodiment of the first electrode layer 20. The segment electrodes 22 may be disposed on a first surface of the substrate 10, and a plurality of a via hole 12 may be extended into and through a thickness of the substrate 10. The via holes 12 may correspond to the segment electrodes 22, respectively. Each of the via holes 12 is an enclosed opening penetrating the substrate 10, such that the substrate 10 solely defines the enclosed via hole 12. The substrate 10 includes only the segment electrodes 22, unlike the substrate in FIG. 2 where the substrate 10 also includes the wire 24 and the terminal 25.

An electrical wiring layer 60, in which a wire 62 for independently applying a voltage to the segment electrodes 22 is installed, may be a separate element from the substrate 10. The electrical wiring layer 60 includes a plurality of the wire 62, a plurality of a first terminal 64 and a plurality of a second terminal 65. Each of the wires 62 is connected at a first end to a first terminal 64 disposed on a first surface of the electrical wiring layer 60. Each of the via holes 12 in the substrate 10 is completely filled with a conductor 14, and the conductor 14 is connected to a second terminal 65 that is disposed at a second end of the wire 62 opposing the first end. The via holes 12 are aligned with the second terminals 65, in the plan view of the substrate 10. The electrical wiring layer 60 includes only the wire 62 and the terminals 64 and 65, unlike the wire 24 and the terminal 25 in FIG. 2 being on a same surface as the segment electrodes 22.

In FIGS. 3A and 3B, the electrical wiring layer 60 is disposed separately from the first electrode layer 20 (see FIG. 1). Thus, a wiring process is more easily performed compared to the wiring process performed in the electrode structure of FIG. 2. Also, in FIGS. 3A and 3B, an area for a wiring space is increased by being disposed on a separate layer from the substrate 10, so that the number of segment electrodes 22 may be increased on the substrate 10.

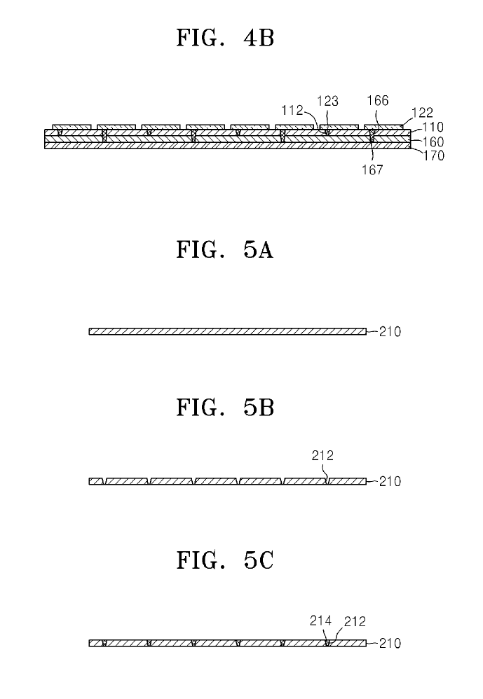

Although, in FIGS. 3A and 3B, one electrical wiring layer 60 is employed, a plurality of electrical wiring layers may be used to form the inorganic electroluminescent device. FIGS. 4A and 4B illustrate an embodiment in which first and second electrical wiring layers 160 and 170 are separate elements.

Referring to FIGS. 4A and 4B, a plurality of a segment electrode 122 is disposed on a substrate 110. The first electrical wiring layer 160 includes a plurality of a first wire 162 for applying a voltage to a portion of the segment electrodes 122, and the second electrical wiring layer 170 includes a plurality of a second wire 172 for applying a voltage to a remaining portion of the segment electrodes 122. In one embodiment, for example, when the segment electrodes 122 are disposed in the form of an n×m matrix, the first electrical wiring layer 160 may be used to apply a voltage to the segment electrodes 122 disposed in even-numbered rows, and the second electrical wiring layer 170 may be used to apply a voltage to the segment electrodes 122 disposed in odd-numbered rows. That is, a first portion (e.g., even-numbered rows) of the segment electrodes 122 applied with a voltage from the first electrical wiring layer 160 is alternated with a second (remaining) portion (e.g., odd-numbered rows) of the segment electrodes 122 applied with a voltage from the second electrical wiring layer 170.

First via holes 112 may be extended through a thickness of the substrate 110, so that the segment electrodes 122 disposed in the even-numbered rows and the first wire 162 of the first electrical wiring layer 160 may be connected to each other. A first conductor 123 may be completely filled into each of the first via holes 112. Each of the first via holes 112 is an enclosed opening penetrating the substrate 110, such that the substrate 110 solely defines the enclosed via hole 112. The first via holes 112 are aligned with terminals of the first electrical wiring layer 160.

Second via holes 166, which are extended through both the thickness of the substrate 110 and a thickness of the first electrical wiring layer 160, may be provided so that the segment electrodes 122 disposed in the odd-numbered rows and the second wire 172 of the second electrical wiring layer 170 may be connected to each other. A second conductor 167 may be filled into each of the second via holes 166. Each of the second via holes 166 is an enclosed opening penetrating the substrate 110 and the first electrical wiring layer 160, such that the substrate 110 and the first electrical wiring layer 160 solely defines the enclosed second via hole 166. The second via holes 166 in the substrate 110 and the first electrical wiring layer 160 are aligned with each other, and aligned with terminals of the second electrical wiring layer 170.

In the illustrated embodiment, a plurality of a segment electrode is divided into a plurality of groups, and a plurality of electrical wiring layers for applying a voltage to the segment electrodes within each of the groups is provided so that a degree of integration of the segment electrodes may be improved. Thus, when a display device is implemented using an inorganic electroluminescence device, images having high resolution may be displayed. One or more of the segment electrodes may correspond to one pixel, and when a voltage is applied to a predetermined segment electrode, an electrical field is generated in the pixel. With the generated electrical field, a phosphor layer emits light and thus, the inorganic electroluminescence device is turned on. Since light is not emitted in a pixel to which a voltage is not applied, the inorganic electroluminescence device is turned off.

Next, an operation of the inorganic electroluminescence device of FIG. 1 will be described. When a voltage is applied to the inorganic electroluminescence device of FIG. 1, an electrical field is generated. With the generated electric field, electrons that are discharged through a phosphor layer and accelerated due to the electrical field collide with a phosphor material of the phosphor layer, and light is emitted. When a voltage is applied to the inorganic electroluminescence device of FIG. 1, the voltage is applied to each of segment electrodes so as to turn on or turn off the inorganic electroluminescence device of FIG. 1 so that a cross-talk may be reduced and brightness of the inorganic electroluminescence device of FIG. 1 may be improved, compared to a cross-talk and brightness of an inorganic electroluminescence device having a structure for applying a voltage to each of segment electrodes in units of lines.

Manufacturing costs of the inorganic electroluminescence device that is turned on/turned off by applying a voltage to each of the segment electrodes are low, compared to an inorganic electroluminescence device driven by active matrix driving that is a general matrix driving method, and the segment electrodes of the inorganic electroluminescence device that is turned on/turned off by applying a voltage to each of the segment electrodes may be independently driven.

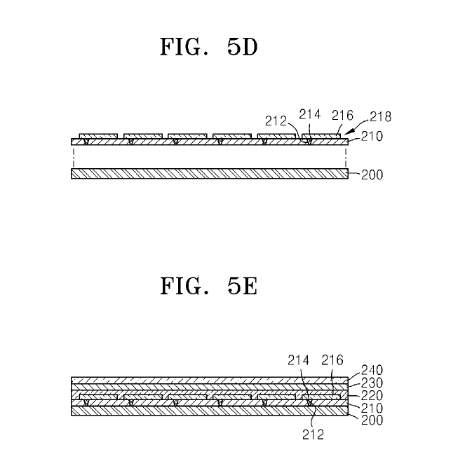

FIGS. 5A through 5E are cross-sectional views illustrating an embodiment of a method of manufacturing an inorganic electroluminescence device, according to the present invention. Referring to FIG. 5A, a substrate 210 is prepared. Referring to FIG. 5B, the substrate 210 is etched using a mask so as to form via holes 212. The via holes 212 may be formed extended completely through a thickness of the substrate 210. Referring to FIG. 5C, a conductor 214 is completely filled into each of the via holes 212. A single continuous first electrode layer 218 is stacked on the substrate 210. Referring to FIG. 5D, the first electrode layer 218 is patterned so as to form a plurality of a segment electrode 216. The conductor 214 and the first electrode layer 218 may be formed of transparent material having good conductivity, and/or may be formed of a same material.

In one embodiment, for example, the plurality of segment electrodes 216 may be formed by patterning a conductive paste, such as by using a screen printing process. The segment electrodes 216 correspond to the via holes 212, respectively, and are separated from each other in a plan view of the substrate 210.

An electrical wiring layer 200 is formed. Alternatively, a plurality of the electrical wiring layer 200 may be formed. When the electrical wiring layer 200 includes a plurality of layers, via holes that will be connected to respective portions of the via holes 212 formed in the substrate 210, may be formed in the electrical wiring layer 200. The position or number of via holes formed in the electrical wiring layer 200 may be adjusted by efficient electrical wiring design, according to arrangement of segment electrodes 216.

Referring again to FIG. 5D, after the substrate 210, the first electrode layer 218 and the electrical wiring layer 200 are aligned based on the via holes 212, the substrate 210, the first electrode layer 218 and the electrical wiring layer 200 may be simultaneously fired by using a low temperature co-firing ceramics (“LTCC”) process. Referring to FIG. 5E, a phosphor layer 220, a dielectric layer 230, and a second electrode layer 240 may be stacked directly on and contacting the first electrode layer 218, by using a screen printing process, for example.

As described above, the embodiments of the inorganic electroluminescence device according to the present invention are driven by passive matrix driving, so that manufacturing costs of the inorganic electroluminescence device may be low, a cross-talk may be reduced and brightness of the inorganic electroluminescence device may be improved.

It should be understood that the embodiments described herein should be considered in a descriptive sense only and not for purposes of limitation. Descriptions of elements within each embodiment should typically be considered as available for other similar elements in other embodiments.

What is claimed is:

1. An inorganic electroluminescence device comprising:
a substrate;
a first electrode layer comprising a plurality of segment electrodes on an upper surface of the substrate and separated from each other;
a phosphor layer on the first electrode layer;
a dielectric layer on the phosphor layer; and
a second electrode layer on the dielectric layer.

2. The inorganic electroluminescence device of claim 1, wherein the substrate comprises a wire which applies a voltage to each of the plurality of segment electrodes.

3. The inorganic electroluminescence device of claim 1, further comprising an electrical wiring layer separate from the substrate and including a wire which applies a voltage to each of the plurality segment electrodes, the wire facing a lower surface of the substrate.

4. The inorganic electroluminescence device of claim 3, further comprising:
via holes extended through the substrate and overlapping the plurality of segment electrodes, respectively, and
a conductor which completely fills each of the via holes,
wherein each of the segment electrodes is electrically connected to the wire of the electrical wiring layer, via the conductor.

5. The inorganic electroluminescence device of claim 1, further comprising a plurality of an electrical wiring layer separate from the substrate and each including a wire which applies a voltage to each of the plurality segment electrodes, the wire facing a lower surface of the substrate.

6. The inorganic electroluminescence device of claim 5, further comprising:
first via holes extended through the substrate and corresponding to a portion of the plurality of segment electrodes; and
second via holes extended through at least one of the substrate and the plurality of electrical wiring layers, and corresponding to a remaining portion of the plurality of segment electrodes.

7. The inorganic electroluminescence device of claim 1, wherein a voltage is independently applied to each of the plurality of segment electrodes.

8. The inorganic electroluminescence device of claim 1, wherein the plurality of segment electrodes are arranged in a form of a matrix.

9. The inorganic electroluminescence device of claim 1, wherein the second electrode layer comprises a common electrode.

10. The inorganic electroluminescence device of claim 1, wherein the inorganic electroluminescence device is configured to be driven by passive matrix driving.

11. A method of manufacturing an inorganic electroluminescence device, the method comprising:
forming first via holes extended through a substrate;
filling a conductor into each of the first via holes;
stacking a first electrode layer directly on the substrate;
patterning the first electrode layer by using a screen printing process so as to form a plurality of a segment electrode;
forming a first electrical wiring layer separate from the substrate to be electrically connected to the conductor filled into each of the first via holes;
aligning the substrate, the first electrode layer, and the first electrical wiring layer based on the conductor filled into each of the first via holes and firing the substrate, the first electrode layer, and the first electrical wiring layer by using a low temperature co-firing ceramics process;
stacking a phosphor layer directly on the first electrode layer;
stacking a dielectric layer directly on the phosphor layer; and
stacking a second electrode layer directly on the dielectric layer.

12. The method of claim 11, further comprising:
forming at least one second electrical wiring layer separate from the first electrical wiring layer and disposing the at least one second electrical wiring layer facing a lower surface of the first electrical wiring layer; and
forming second via holes extended through the first electrical wiring layer, and aligning the second via holes with the first via holes.

13. The method of claim 11, wherein the plurality of segment electrodes are disposed in a form of a matrix.

14. The method of claim 11, wherein the second electrode layer comprises a common electrode.
